(19) United States
(12) Patent Application Publication
(10) Pub. No.: US 2026/0322307 A1
(43) Pub. Date: Oct. 15, 2026

(54) METHOD FOR INJECTING HARMONICS IN A CURRENT- OR FLUX-CONTROLLED PERMANENT MAGNET SYNCHRONOUS MACHINE

(71) Applicant: MAGNA Powertrain GmbH & Co KG, Lannach (AT)

(72) Inventors: Bernd KOLAR, Pucking (AT); Andreas FICHTINGER, Wien (AT)

(21) Appl. No.: 19/632,702

(22) Filed: Mar. 30, 2026

(30) Foreign Application Priority Data
Apr. 1, 2025 (DE) 102025112624.0

(51) Int. Cl. H02P 29/50; H02P 21/12; H02P 21/14

(52) U.S. Cl. CPC H02P 29/50; H02P 21/12; H02P 21/14; H02P 2207/05

(57) ABSTRACT

A method for injecting harmonics in a current- or flux-controlled permanent magnet synchronous machine (1), wherein a current controller (2) or a flux controller calculates an output voltage for a reference current or a reference flux, respectively, wherein the permanent magnet synchronous machine (1) is supplied with an input voltage dependent on the calculated output voltage, wherein the current controller (2) receives as a reference current a desired fundamental current (i_{dq,f,ref}), such that the current controller (2) regulates the fundamental current (i_{dq,f,ref}), wherein the measured current (i_{dq}) is modified by subtracting desired current harmonics (i_{dq,h}), so that, ideally, only the fundamental current (i_{dq,f}) remains and the output voltage of the current controller (2) is the desired fundamental voltage (u_{dq,f}), wherein associated voltage harmonics (u_{dq,h}) are subsequently added in the forward direction, after the current controller (2) and before the permanent magnet synchronous machine (1), to the fundamental voltage (u_{dq,f}),

or wherein the flux controller is operated in a similar manner, as well as an electric or hybrid vehicle comprising a current- or flux-controlled permanent magnet synchronous machine (1) as a drive motor and a control unit, wherein the control unit is configured to perform such a method.

### CROSS-REFERENCE TO RELATED APPLICATIONS

This application claims priority to German Application No. DE 102025112624.0, filed on Apr. 1, 2025. The entire disclosure of the above application is incorporated herein by reference.

### FIELD OF THE INVENTION

The present invention relates to a method for injecting harmonics in a current- or flux-controlled permanent magnet synchronous machine.

### BACKGROUND OF THE INVENTION

It is known that permanent magnet synchronous machines (PMSMs) can be used, for example, in motor vehicles as drive motor. To control a permanent magnet synchronous machine, control methods that regulate the current or flux of the permanent magnet synchronous machine can be applied.

During operation, permanent magnet synchronous machines can generate unpleasant vibrations and thus noise. For applications such as noise reduction, it is known to introduce pre-calculated current harmonics—or, equivalently, pre-calculated flux harmonics—into a permanent magnet synchronous machine so that the corresponding harmonics of the torque or radial forces, which cause mechanical vibrations, are reduced.

The desired current harmonics can be introduced either in a closed or open control loop. In the first case, the current harmonics are provided as a setpoint for a current controller. In the second case, however, the desired current harmonics are translated into corresponding voltage harmonics based on a machine model, and these voltage harmonics are added to the fundamental voltage provided by the current controller. The current controller thus receives only the desired fundamental currents as a setpoint, and the harmonics are introduced in the form of a feedforward control.

If the desired current harmonics are specified as a setpoint for a current controller, the controller's tracking behavior must be sufficiently fast so that the harmonics can be realized with acceptable quality. Depending on the order of the harmonics under consideration, this approach is therefore only feasible up to a certain speed limit, which is determined by the controller's bandwidth.

If the harmonics are introduced only in the feedforward control via the corresponding voltage harmonics, a high bandwidth of the current controller is not required. The quality of the generated current harmonics then depends primarily on the ratio of the switching frequency to the electrical fundamental frequency, as well as on the accuracy of the machine model used to calculate the required voltage harmonics from the desired current harmonics.

However, if the current controller receives only the desired fundamental currents as a reference and compares them with the measured currents, it will attempt to eliminate all harmonics. In other words: The feedforward control of the voltage harmonics and the current controller work against each other. If the current controller has a high bandwidth, the quality of the resulting current harmonics deteriorates, particularly at low speeds.

For example, DE 10 2020 122 099 A1 discloses a method for modulating the torque ripple and/or the radial force of a three-phase electric machine, in particular an electric drive motor of a powertrain of an electric vehicle, comprising the method steps: selecting at least one harmonic in the torque of the electric machine and/or selecting at least one harmonic of a load of the powertrain coupled to the electric machine, and modulating the at least one selected harmonic by injecting the at least one selected harmonic onto the d-current and/or q-current or to a quantity correlated therewith to generate a reference value for controlling the electric motor, wherein the phase angle of the harmonic in the d-current and/or the harmonic in the q-current relative to the rotor angle is set to be different, at least temporarily.

### SUMMARY OF THE INVENTION

It is an object of the invention to provide a method for injecting harmonics in a current- or flux-controlled permanent magnet synchronous machine that efficiently and cost-effectively reduces harmonics and thus undesirable noise behavior of a permanent magnet synchronous machine. Another objective of the invention is to provide an electric or hybrid vehicle comprising a permanent magnet synchronous machine with improved noise characteristics.

The problem is solved by a method for injecting harmonics in a current—or flux-controlled permanent magnet synchronous machine, wherein a current controller or a flux controller calculates an output voltage for a reference current or a reference flux, respectively, wherein the permanent magnet synchronous machine is supplied with an input voltage dependent on the calculated output voltage, wherein the current controller receives a desired fundamental current as the reference current, such that the current controller regulates the fundamental current, wherein the measured current is modified by subtracting desired current harmonics, so that, ideally, only the fundamental current remains and the output voltage of the current controller is the desired fundamental voltage, wherein voltage harmonics are subsequently added to the fundamental voltage in the forward direction, after the current controller and before the permanent magnet synchronous machine, or that the flux controller receives a desired fundamental flux as a reference flux, such that the flux controller regulates the fundamental flux, wherein the measured flux is modified by subtracting desired flux harmonics, so that, ideally, only the fundamental flux remains and the output voltage of the flux controller is the desired fundamental voltage, wherein voltage harmonics are subsequently added in the forward direction, after the flux controller and before the permanent magnet synchronous machine, to the fundamental voltage.

According to the invention, a permanent magnet synchronous machine is controlled based on current or flux. In this process, the specified reference value—i.e., the reference current or reference flux—is set as the controller's setpoint for the desired fundamental variable, without taking harmonics into account at this stage, so that the controller regulates only the fundamental variable. Additionally, the measured value, in particular the measured current or flux, is modified at the controller by subtracting desired harmonics, and voltage harmonics corresponding to the resulting fundamental voltage are subsequently added at the controller's output.

The invention thus improves harmonic injection. The most important innovation consists in combining harmonic injection via feedforward control with current or flux control in such a way that they do not work against each other. The interaction between feedforward control and current or flux control is improved.

Since the fundamental current is constant in dq coordinates, the proposed solution for harmonic injection does not require a special current or flux controller with fast tracking behavior. A standard controller is sufficient.

The terms “fundamental current,” “fundamental voltage,” and “fundamental flux” may also be referred to as “fundamental wave current,” “fundamental wave voltage,” and “fundamental wave flux,” although these are constant in dq coordinates within the scope of the present invention.

The condition that only the fundamental current or fundamental flux is preserved is met when no harmonics other than the desired ones occur in the measured current or flux.

The term “ideally” refers to the desired, ideal situation in which the desired and actual harmonics coincide.

The use of the plural “harmonics” in the described solution, for example in “current harmonics” and “voltage harmonics,” refers to the fact that, on the one hand, the harmonics of i_{d} and i_{q} can be completely independent of one another in amplitude and phase, and that, moreover, generally several harmonics, i.e., several orders, can be considered simultaneously. However, the method is not limited to the requirement that several orders of harmonics must be fed in.

Further embodiments of the invention are described in the dependent claims, the description, and the accompanying drawings.

Preferably, the desired current harmonics or the desired flux harmonics, as well as the associated voltage harmonics, are taken from lookup tables.

For the current harmonics or the flux harmonics, as well as for the voltage harmonics, amplitudes and phases are preferably taken from the lookup tables. It is particularly preferred that the lookup tables be parameterized by torque and rotational speed.

Preferably, the desired current harmonics or the desired flux harmonics and the associated voltage harmonics, which are stored in the lookup tables, are calculated using a permanent-magnet synchronous machine model that takes into account the dependence of the linked fluxes on the electrical rotor angle.

Preferably, during operation, the current harmonics or the flux harmonics, as well as the voltage harmonics, are retrieved from the lookup tables together with the electrical rotor angle to reconstruct the respective harmonics in the time domain. As already described, the lookup tables preferably store the amplitudes and phases of the harmonics, from which the signals in the time domain can then be reconstructed using the electrical rotor angle.

The current controller or the flux controller is preferably implemented in a time-discrete manner, such that it uses or outputs constant values over a sampling interval, wherein the current harmonics or the flux harmonics, and/or the voltage harmonics, are preferably formed from average values over the sampling interval.

Preferably, averaging is performed in dq coordinates or in stator-fixed phase coordinates UVW.

An electric or hybrid vehicle according to the invention comprises a current- or flux-controlled permanent magnet synchronous machine as a drive motor and a control unit, wherein the control unit is configured to execute a method as described above.

### BRIEF DESCRIPTION OF THE DRAWINGS

The invention is described below by way of example with reference to the drawings.

FIG. 1 is a block diagram of a method according to the invention.

### DETAILED DESCRIPTION OF THE INVENTION

First, the theoretical background of the invention is described, in particular the relationship between voltage harmonics—i.e., voltage harmonics u_{dq,h}—on the one hand, and current or flux harmonics—i.e., harmonics i_{dq,h}, Ψ_{dq,h}—on the other hand in permanent magnet synchronous machines (PMSMs). Although it is usually neglected in controller design, the linked fluxes Ψ_{d} and Ψ_{q} of a PMSM depend not only on the currents i_{d} and i_{q}, but also on the electrical rotor angle φₑₗ. This angular dependence is essential for the relationship between the applied voltage harmonics
u_{dq,h}=[u_{d,h} u_{q,h}]^{T} and the resulting current harmonics
i_{dq,h}=[i_{d,h} i_{q,h}]^{T}.

If one takes into account the angular dependence of the linked fluxes, the differential equations describing the behavior of a PMSM in rotor-fixed dq coordinates result as follows:

$$\frac{d {Ψ}_{d}}{dt} = \frac{\partial {Ψ}_{d}}{\partial {i}_{d}} \frac{\partial {i}_{d}}{\partial t} + \frac{\partial {Ψ}_{d}}{\partial {i}_{q}} \frac{\partial {i}_{q}}{\partial t} + \frac{\partial {Ψ}_{d}}{\partial {φ}_{el}} {ω}_{el} = {u}_{d} - {Ri}_{d} + {ω}_{el} {Ψ}_{q} ( {i}_{d} , {i}_{q} , {φ}_{el} )$$

$$\frac{d {Ψ}_{q}}{dt} = \frac{\partial {Ψ}_{q}}{\partial {i}_{d}} \frac{\partial {i}_{d}}{\partial t} + \frac{\partial {Ψ}_{q}}{\partial {i}_{q}} \frac{\partial {i}_{q}}{\partial t} + \frac{\partial {Ψ}_{q}}{\partial {φ}_{el}} {ω}_{el} = {u}_{q} - {Ri}_{q} - {ω}_{el} {Ψ}_{d} ( {i}_{d} , {i}_{q} , {φ}_{el} )$$

For a given electrical angular velocity ωₑₗ, a steady-state operating point of a PMSM can be described equivalently by the fundamental voltageu_{dq,f}=[u_{d,f} u_{q,f}]^{T} or the fundamental current i_{dq,f}=[i_{d,f} i_{q,f}]^{T}, both of which are constant in the rotor-fixed dq coordinate system. For each operating point, the above differential equations establish a one-to-one correspondence between the additional voltage harmonics u_{dq,h} and the resulting steady-state current harmonics i_{dq,h}. This means that if, for example, it is desirable to introduce specific current harmonics at a certain operating point in order to reduce the harmonics of the torque or radial forces and thereby improve the NVH behavior of the PMSM, then the required voltage harmonics that must be applied can be uniquely determined. The same applies if flux harmonics are specified instead of current harmonics. To derive the relationship between voltage harmonics and the corresponding current or flux harmonics, it may also be useful to linearize the above differential equations around the operating point under consideration, as this facilitates the calculation of the steady-state, i.e., settled, behavior of the system.

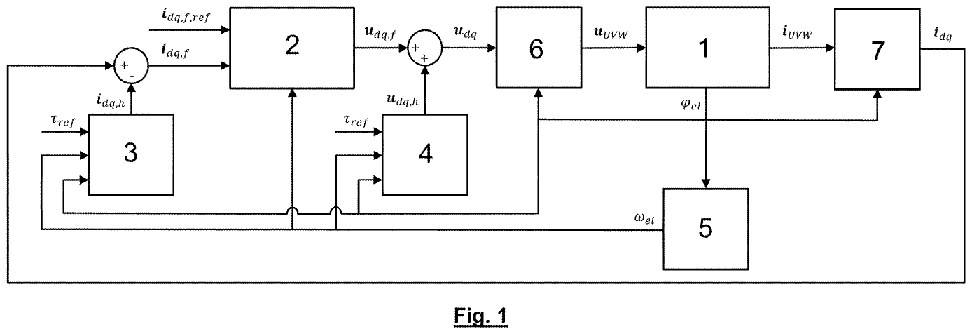

The integration of harmonic injection into the control loop is described in more detail below. The block diagram in FIG. 1 illustrates the proposed method of harmonic injection.

The desired current harmonics i_{dq,h} as well as the corresponding voltage harmonics u_{dq,h} are stored in lookup tables 3 and 4, which contain the amplitude and phase of the harmonics for the considered range of operating points. The operating points can, for example, be parameterized by torquer and rotational speed—which is advantageous compared to using fundamental current i_{dq,f} and rotational speed, which would increase the dimension of lookup tables 3 and 4 by one.

During operation, the amplitude and phase values from lookup tables 3 and 4, together with the electrical rotor angle φₑₗ(t), are used to reconstruct the voltage harmonics u_{dq,h} (t) and the current harmonics i_{dq,h} (t) in the time domain. The relationship between the amplitude and phase values of the harmonics under consideration and the time signals resulting from the superposition of these harmonics has the following form:

$${u}_{d , h} ( t ) = \text{?} {\hat{u}}_{d , j} cos ( j {φ}_{el} ( t ) + {φ}_{{u}_{d , j}} )$$

$${u}_{q , h} ( t ) = \text{?} {\hat{u}}_{q , j} cos ( j {φ}_{el} ( t ) + {φ}_{{u}_{q , j}} )$$

$${i}_{d , h} ( t ) = \text{?} {\hat{i}}_{d , j} cos ( j {φ}_{el} ( t ) + {φ}_{{i}_{d , j}} )$$

$${i}_{q , h} ( t ) = \text{?} {\hat{i}}_{q , j} cos ( j {φ}_{el} ( t ) + {φ}_{{i}_{q , j}} )$$

$$\text{?} \text{indicates text missing or illegible when filed}$$

The amplitudes and phases may differ for the d and q directions, and, at least theoretically, any number of harmonics (index j) can also be considered simultaneously. However, in practice—for example, in noise reduction applications—if the goal is to reduce the 6th and 12th electrical harmonics of the torque and/or radial force, then generally only the corresponding 6th and 12th voltage and current harmonics need to be considered. Therefore, only the 6th and 12th harmonics are stored in lookup tables 3 and 4, and all other harmonics in the above formulas, with the exception of j=6 and j=12, are zero.

A key feature of the method according to the invention is that the current controller 2 is configured to control only the fundamental current i_{dq,f} (or, in the case of a flux controller, the fundamental flux). More specifically, the current controller 2 receives as a reference a desired reference fundamental current i_{dq,f,ref}, and the measured current i_{dq} is modified by subtracting the desired current harmonics i_{dq,h}, so that ideally—that is, when the actual and desired current harmonics match—only the fundamental current i_{dq,f} remains. The output of current controller 2 is therefore only the desired fundamental voltage u_{dq,f}, and the voltage harmonics u_{dq,h} are subsequently added in the forward direction. Since the fundamental current is constant in dq coordinates, the proposed approach for harmonic injection does not require a special current controller with fast tracking behavior—a standard current controller is sufficient. If a flux controller is used instead of a current controller, the approach can be easily adapted by replacing currents with fluxes.

As shown in FIG. 1, the voltage value obtained from the fundamental voltage u_{dq,f} and the added voltage harmonics u_{dq,h} in dq coordinates, u_{dq}, is fed to the permanent magnet synchronous machine 1 following a dq/UVW transformation 6. The voltages u_{UVW} can be generated from the DC voltage supplied by the battery using a suitable modulation method, such as space-vector pulse-width modulation, and an inverter, before they can be fed to the permanent magnet synchronous machine. The phase currents i_{UVW} occurring at the permanent magnet synchronous machine 1 are, following a UVW/dq transformation 7, fed back to the current controller 2 as the basis for calculating the current fundamental current i_{dq,f}.

Note: A current controller often includes a feedforward control section that calculates the output voltage directly based on the requested reference current i_{dq,ref}. It would be incorrect to assume that the use of lookup tables is not beneficial for both current and voltage harmonics and that it would suffice to simply add the desired current harmonics to the reference current. The application of a reference signal i_{dq,ref}=i_{dq,f,ref}+i_{dq,h} for the current controller—and its comparison with the full measured current i_{dq}—would not yield the same voltage u_{dq}=u_{dq,f}+u_{dq,h} as in our approach. The reason for this is that the relationship between current harmonics i_{dq,h} and voltage harmonics u_{dq,h} is preferably calculated based on a PMSM model that takes into account the very important dependence of the linked fluxes Ψ_{d} and Ψ_{q} on the electrical rotor angle φₑₗ. Incorporating this precise, angle-dependent model into a current controller is generally not feasible due to limitations regarding memory and computational requirements. Without this angle-dependent motor model, the current controller cannot calculate the correct voltage harmonics.

The following is a description of implementation aspects in a discrete-time control loop. On a microcontroller, only a discrete-time implementation of the control loop is possible, which means that the voltage u_{dq} (t) to be applied to the PMSM 1 cannot be continuously varied. Instead, it is kept constant in discrete steps over each sampling interval. This raises the question of how the voltage harmonics u_{dq,h} (t) can be evaluated, since simply applying u_{dq,h,k}=u_{dq,h} (KTα) over the sampling interval from t=kTα to t=(k+1)Tα introduces an error. A more accurate realization of the desired voltage harmonics can be achieved by applying the desired mean value

$${u}_{dq , h , k} = \frac{1}{{T}_{a}} {{\int }_{{kT}_{a}}}^{( k + 1 ) {T}_{a}} {u}_{dq , h} ( t ) dt$$

Even greater accuracy can be achieved by converting the desired voltage harmonics into stator-fixed phase coordinates u_{UVW,h} (t) and applying the desired average value:

$${u}_{UVW , h , k} = \frac{1}{{T}_{a}} {{\int }_{{kT}_{a}}}^{( k + 1 ) {T}_{a}} {u}_{UVW , h} ( t ) dt$$

This naturally requires that the summation of the fundamental voltage from the current controller and the desired harmonics also be performed in phase coordinates.

A similar question arises regarding the evaluation of the desired current harmonics i_{dq,h} (t). If, for example, the currents are measured at the beginning of each sampling interval, the current harmonics must be evaluated according to i_{dq,h,k}=i_{dq,h} (kTα). However, if current oversampling is used, the resulting current values represent approximate averages over the preceding sampling interval. In this case, the desired current harmonics should be evaluated by determining the average value over this sampling interval according to

$${i}_{dq , h , k} = \frac{1}{{T}_{a}} {{\int }_{( k - 1 ) {T}_{a}}}^{{kT}_{a}} {i}_{dq , h} ( t ) dt$$

or even according to

$${i}_{UVW , h , k} = \frac{1}{{T}_{a}} {{\int }_{( k - 1 ) {T}_{a}}}^{{kT}_{a}} {i}_{UVW , h} ( t ) dt$$

in stator-fixed phase coordinates.

The proposed method of harmonic injection enables precise injection of the desired harmonics across a wide speed range using a feedforward approach, ensuring that the current controller does not intervene undesirably. A typical application is noise shaping, where the goal is to introduce harmonics to improve the NVH behavior of the permanent magnet synchronous machine. Such noise shaping or noise reduction can be very helpful in meeting specified NVH requirements without requiring costly hardware modifications, such as changes to the motor design or even an NVH cover.

1. A method for injecting harmonics in a current- or flux-controlled permanent magnet synchronous machine, wherein a current controller or a flux controller calculates an output voltage for a reference current or a reference flux, respectively, wherein the permanent magnet synchronous machine is supplied with an input voltage dependent on the calculated output voltage, wherein the current controller receives as a reference current a desired fundamental current (i_{dq,f,ref}), such that the current controller controls the fundamental current (i_{dq,f,ref}), wherein the measured current (i_{dq}) is modified by subtracting desired current harmonics (i_{dq,h}), so that, ideally, only the fundamental current (i_{dq,f}) remains and the output voltage of the current controller is the desired fundamental voltage (u_{dq,f}), wherein associated voltage harmonics (u_{dq,h}) are subsequently added in the forward direction, after the current controller and before the permanent magnet synchronous machine, to the fundamental voltage (u_{dq,f}),
or wherein the flux controller receives a desired fundamental flux (Ψ_{dq,f,ref}) as a reference flux, such that the flux controller regulates the fundamental flux (Ψ_{dq,f,ref}), wherein the measured flux (Ψ_{dq}) is modified by subtracting desired flux harmonics (Ψ_{dq,h}), so that, ideally, only the fundamental flux (Ψ_{dq,f}) remains and the output voltage of the flux controller is the desired fundamental voltage (u_{dq,f}), wherein associated voltage harmonics (u_{dq,h}) are subsequently added in the forward direction, after the flux controller and before the permanent magnet synchronous machine (1), to the fundamental voltage (u_{dq,f}).

2. The method according to claim 1,
wherein the desired current harmonics (i_{dq,h}) or the desired flux harmonics (Ψ_{dq,h}), as well as the corresponding voltage harmonics (u_{dq,h}), are retrieved from lookup tables.

3. The method according to claim 2,
wherein for the desired current harmonics (i_{dq,h}) or the desired flux harmonics (Ψ_{dq,h}), as well as the associated voltage harmonics (u_{dq,h}), amplitudes and phases are taken from the lookup tables, wherein the lookup tables are preferably parameterized by torque (τ_{ref}) and rotational speed.

4. The method according to claim 2,
wherein the desired current harmonics (i_{dq,h}) or the desired flux harmonics (Ψ_{dq,h}), and the associated voltage harmonics (u_{dq,h}) in the lookup tables were calculated using a permanent magnet synchronous machine model that takes into account the dependence of the linked fluxes (Ψ_{d}) and (Ψ_{q}) on the electrical rotor angle (φₑₗ).

5. The method according to claim 2,
wherein during operation, the current harmonics (i_{dq,h}) or the flux harmonics (Ψ_{dq,h}), as well as the voltage harmonics (u_{dq,h}), are used from the lookup tables together with the electrical rotor angle (φₑₗ(t)) to reconstruct the current harmonics (i_{dq,h} (t)) or the flux harmonics (Ψ_{dq,h} (t)), as well as the voltage harmonics (u_{dq,h} (t)), in the time domain.

6. The method according to claim 1,
wherein the current controller or the flux controller is implemented in a time-discrete manner such that it uses constant values over a sampling interval, wherein the current harmonics (i_{dq,h}) or the flux harmonics (Ψ_{dq,h}), and/or the voltage harmonics (u_{dq,h}) are formed from average values over the sampling interval.

7. The method according to claim 6,
wherein the averaging is performed in dq coordinates or that the averaging is performed in stator-fixed phase coordinates UVW.

8. An electric or hybrid vehicle comprising a current- or flux-controlled permanent magnet synchronous machine as a drive motor and a control unit, wherein the control unit is configured to execute a method for injecting harmonics in a current- or flux-controlled permanent magnet synchronous machine, wherein a current controller or a flux controller calculates an output voltage for a reference current or a reference flux, respectively, wherein the permanent magnet synchronous machine is supplied with an input voltage dependent on the calculated output voltage,
wherein the current controller receives as a reference current a desired fundamental current (i_{dq,f,ref}), such that the current controller controls the fundamental current (i_{dq,f,ref}), wherein the measured current (i_{dq}) is modified by subtracting desired current harmonics (i_{dq,h}), so that, ideally, only the fundamental current (i_{dq,f}) remains and the output voltage of the current controller is the desired fundamental voltage (u_{dq,f}), wherein associated voltage harmonics (u_{dq,h}) are subsequently added in the forward direction, after the current controller and before the permanent magnet synchronous machine, to the fundamental voltage (u_{dq,f}),
or wherein the flux controller receives a desired fundamental flux (Ψ_{dq,f,ref}) as a reference flux, such that the flux controller regulates the fundamental flux (Ψ_{dq,f,ref}), wherein the measured flux (Ψ_{dq}) is modified by subtracting desired flux harmonics (Ψ_{dq,h}), so that, ideally, only the fundamental flux (Ψ_{dq,f}) remains and the output voltage of the flux controller is the desired fundamental voltage (u_{dq,f}), wherein associated voltage harmonics (u_{dq,h}) are subsequently added in the forward direction, after the flux controller and before the permanent magnet synchronous machine, to the fundamental voltage (u_{dq,f}).
